(19) United States
(12) Patent Application Publication
(10) Pub. No.: US 2010/0082411 A1
(43) Pub. Date: Apr. 1, 2010

(54) DYNAMIC ADVERTISEMENT MANAGEMENT

(75) Inventors: Prabhakar Goyal, Sunnyvale, CA (US); Eyal Arasu Ramakrishnan, Santa Clara, CA (US); Sumit Mishra, Santa Clara, CA (US); Ilya Slain, Santa Clara, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/242,041

(22) Filed: Sep. 30, 2008

(51) Int. Cl. G06Q 30/00

(52) U.S. Cl. 705/14.4

(57) ABSTRACT

A method and system for generating digital advertisements is provided. A method employed by the system may include receiving template information that that defines dynamic elements of the advertisement, receiving data associated with the dynamic elements, generating browser code based on the template information and the data, and communicating the browser code to a browser. The method may also include receiving a second template that includes a creative applet reference and combining the template information with the browser code. The second template may also include a reference to an alternate image that is rendered when an image defined by the creative applet cannot be rendered.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

As the Internet has advanced, so has the technology associated with Internet advertising. For example, advertisements have gone from displaying simple static information to displaying dynamic information. Dynamic information corresponds to information in an advertisement that may change from impression to impression. In some cases, a portion of an advertisement may be static while a different portion may be dynamic. For example, a hotel advertisement may include static information, such as a name of the hotel, and also dynamic information, such as an occupancy rate.

To support the features above, a typical advertisement requires browser code that enables the features. However, developing the code is not an easy task and may require the skills of a seasoned webpage developer. This makes it difficult for an advertiser with a small advertising budget to take advantage of the benefits of dynamic advertisements.

### BRIEF DESCRIPTION OF THE DRAWINGS

FIG. 1 is a system for generating dynamic advertisements;

FIG. 2 shows an exemplary creative template schema;

FIG. 3 shows an exemplary creative code template;

FIG. 4 shows an exemplary creative data packet;

FIG. 5 shows exemplary fully formatted creative code;

FIG. 6 is a flow diagram that describes several operations that may be performed by the system;

FIG. 7a is a user interface associated with an exemplary dynamic advertisement template (DAT);

FIG. 7b is an exemplary custom user interface based on a DAT;

FIG. 7c is an exemplary dynamic advertisement that may be generated by a user interface based on test data; and

FIG. 8 illustrates a general computer system, which may represent any of the computing devices referenced herein.

### DETAILED DESCRIPTION OF THE DRAWINGS AND THE PRESENTLY PREFERRED EMBODIMENTS

The figures below describe a method and system for generating digital advertisements. A method employed by the system may include receiving template information that defines dynamic elements of the advertisement, receiving data associated with the dynamic elements, generating browser code based on the template information and the data, and communicating the browser code to a browser. The method may also include receiving a second template that includes a creative applet reference and combining the template information with the browser code. The second template may also include a reference to an alternate image that is rendered when an image defined by the creative applet cannot be rendered.

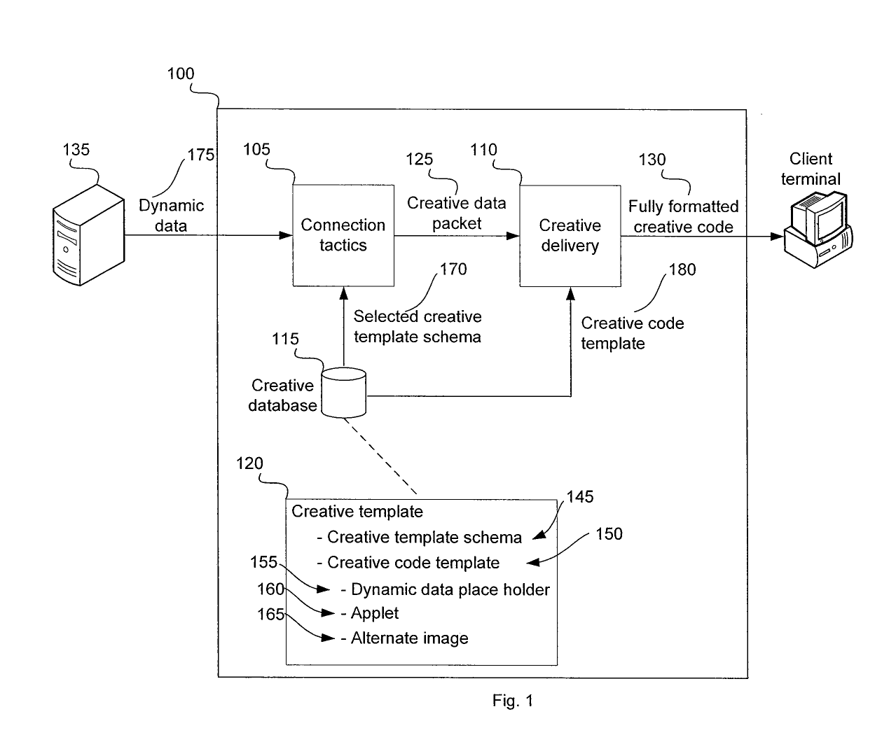

FIG. 1 is a system 100 for generating dynamic advertisements. The system 100 includes a connection tactics subsystem 105, a creative delivery subsystem 110, and a creative database 115. The various components of the system 100 may reside on a computer or be distributed between several computers interconnected by a communication network. The computer may correspond to an Intel®, AMD®, or PowerPC® based computer operating a Microsoft Windows®, Linux, or other Unix® based operating system. The computer may be adapted to communicate with other computers via an interface, such as network interface.

The creative database 115 stores a collection of creative templates 120. A creative template 120 is a client specific instance of a dynamic advertisement. Each creative template 120 includes a creative template schema 145 and a creative code template 150.

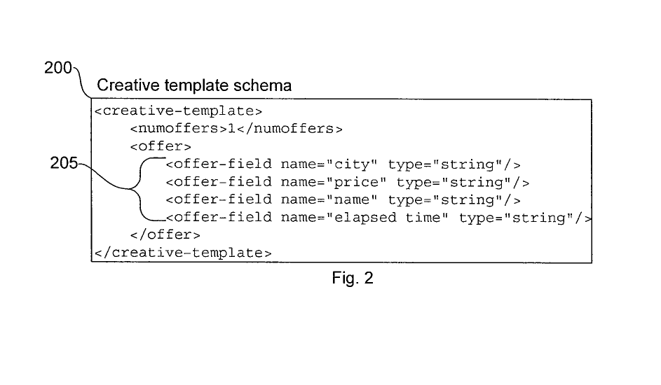

FIG. 2 shows an exemplary creative template schema 200 that may correspond to the creative template schema 145 referred to in FIG. 1. The exemplary creative template schema 200 corresponds to code that defines the dynamic elements of a dynamic advertisement. In this case, the exemplary creative template schema 200 defines four dynamic elements 205 named “city,” “price,” “name,” and “elapsed time.” Each of the dynamic elements 205 are defined as being of type “string.” The dynamic elements 205 may also correspond to different types, such as integer or floating point.

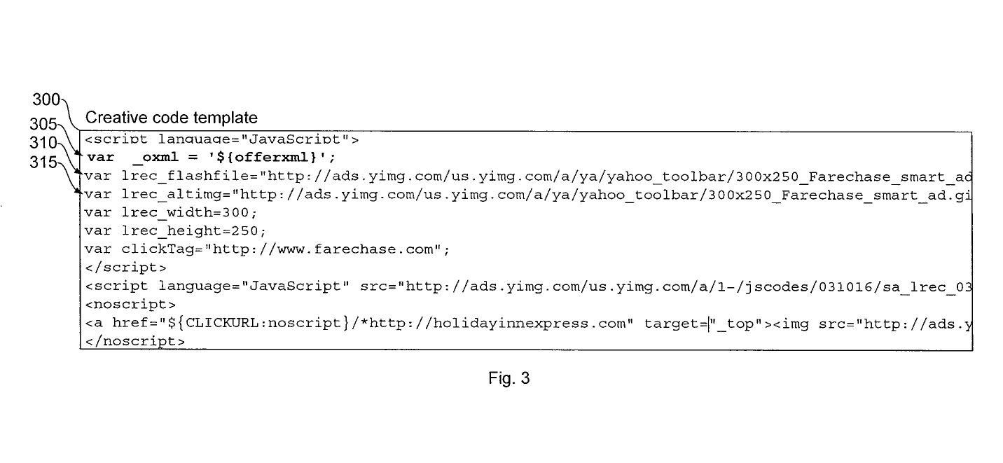

FIG. 3 shows an exemplary creative code template 300 that may correspond to the creative code template 150 referred to in FIG. 1. The exemplary creative code template 300 is code that forms the basis of the dynamic advertisement and may include a dynamic data place holder 305, a reference to an applet 310, and a reference to an alternate image 315. The exemplary creative code template 300 may also include code that detects browser capabilities and code that refers to a landing URL.

The dynamic data place holder 305 is a place holder for a creative data packet. The creative delivery subsystem (described below) replaces the dynamic data place holder 305 with a creative data packet when rendering the dynamic advertisement.

The creative applet 310 encapsulates the graphical elements and logic necessary to render the dynamic advertisement on a browser capable of executing the creative applet 310. In the preferred embodiment, the creative applet 310 is based on Macromedia® shockwave flash technology. Other similar technologies may also be utilized. The creative applet 310 renders the static and customizable elements of the dynamic advertisement. The customizable elements are either contained within the creative applet 310 or are referred to by the creative applet 310. In the preferred embodiment, images are contained within the creative applet 310, whereas more substantial elements, such as video, may be referred to and progressively downloaded by the creative applet 310 when rendering the dynamic advertisement.

The creative applet 310 is also responsible for reading and validating the values in the creative data packet when rendering the dynamic advertisement. Where there is a validation issue, such as a badly formatted creative data packet, the creative applet 310 renders the alternate image 315. In some cases, the creative applet 310 may report clicks or other interactions with the rendered dynamic advertisement to various tracking servers. The creative applet 310 may also be adapted to perform more complicated functions, such as requesting additional dynamic data based on user interactions with the rendered dynamic advertisement

The alternate image 315 is a reference to an image file, such a JPEG file or BMP file. As described above, in situations where the creative applet 310 cannot render the dynamic data, the creative applet 310 may instead render the alternate image 315.

Referring back to FIG. 1, the connection tactics subsystem 145 includes logic, circuitry, and/or code that enables generating a creative data packet 125 based on a selected creative template schema 170 and dynamic data values 175 associated with the selected creative template schema 170.

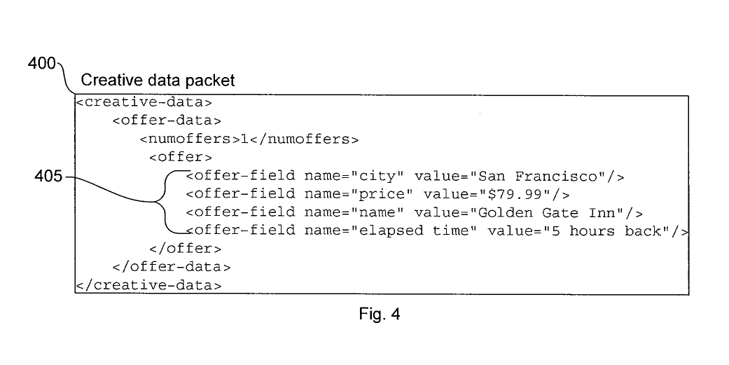

FIG. 4 shows an exemplary creative data packet 400 that may correspond to the creative data packet 125 referred to in FIG. 1. The exemplary creative data packet 400 includes references to dynamic elements 405 specified in a corresponding creative template schema, which in this case is the creative template schema 200 of FIG. 2. The relationship between the creative template schema 200 and the creative data packet 400 is analogous to the “class” and “object instance” in many object-oriented programming languages. The exemplary creative data packet also includes the values associated with the dynamic elements 405. For example, the dynamic element “city” has the value “San Francisco.”

Referring back to FIG. 1, the creative delivery subsystem 110 includes logic, circuitry, and/or code that enables generating browser-ready fully formatted creative code 130. The creative delivery subsystem 110 accomplishes this by combining the creative code template 150 with the creative data packet 125 generated by the connection tactics subsystem 105, so as to generate fully formatted creative code 130.

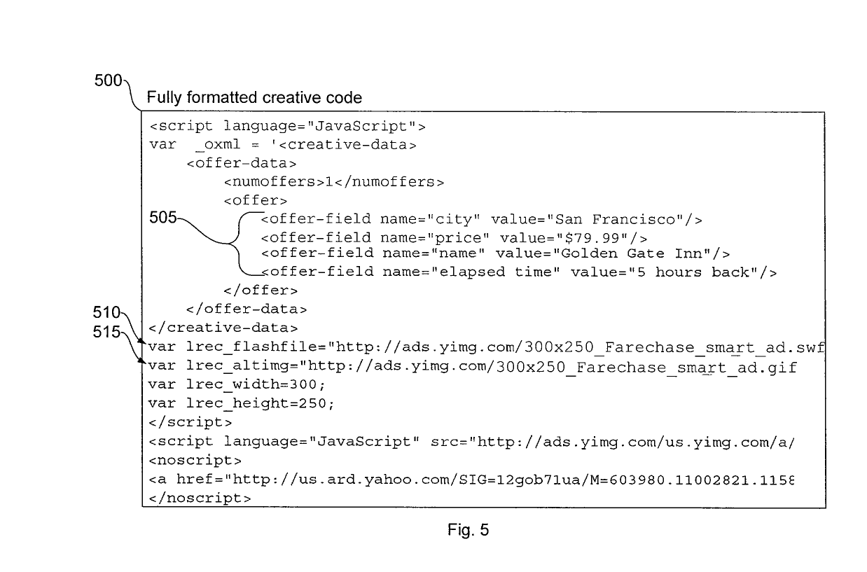

FIG. 5 shows exemplary fully formatted creative code 500 that may correspond to the fully formatted creative code 130 referred to in FIG. 1. The exemplary fully formatted creative code 500 includes code that defines dynamic elements 505, a reference to a creative applet 510, and a reference to an alternate image 515. The code that defines the dynamic elements 505 may correspond to a creative data packet, which in this case is the creative data packet 400 of FIG. 4. The creative applet 510 and alternate image 515 correspond to the applet and alternate image described above.

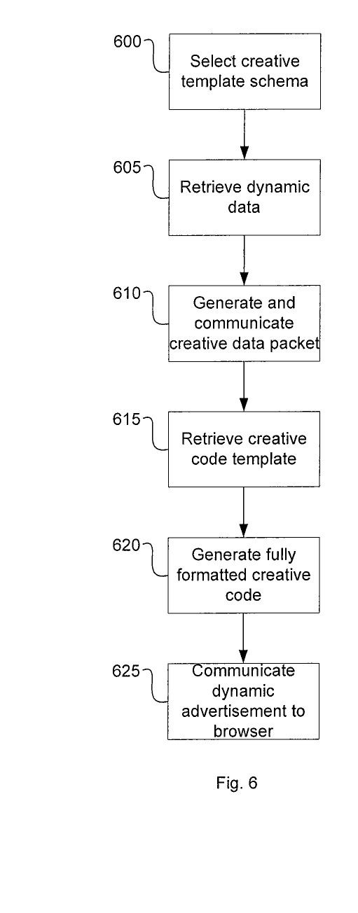

FIG. 6 is a flow diagram that describes several operations that may be performed by the system 100 of FIG. 1. At block 600, a creative template may be selected from a database of creatives. For example, the connection tactics subsystem 105 may select a creative template schema 170 associated with a given dynamic advertisement from the creative template database 115. The creative template schema 170 may correspond to the template schema 200 of FIG. 2.

At block 605, dynamic data values associated with dynamic elements in the creative template schema may be retrieved. For example, the connection tactics subsystem 105 may retrieve dynamic data values 175 associated with the dynamic elements in the selected creative template schema 170. Exemplary dynamic data values 175 may be communicated from a client data server 135 to the connection tactics subsystem 145. The dynamic data values 175 may also be communicated from other servers or other databases.

At block 610, a creative data packet may be generated and communicated to a creative delivery subsystem. For example, the connection tactics subsystem 145 may generate a creative data packet 125. The creative data packet 125 may correspond to an instance of dynamic data formatted according to the selected creative template schema 170. The creative data packet 125 may be generated at serve time, after the connection tactics subsystem 105 runs through the selection process. The creative data packet 125 may correspond to the creative data packet 400 of FIG. 4

At block 615, a creative code template associated with the selected creative template schema may be retrieved. For example, a creative code template 180 associated with the previously selected creative template schema may be communicated to the creative delivery subsystem 110. The creative code template 180 may correspond to the creative code template 300 of FIG. 3.

At block 620, the retrieved creative code template may be combined with the creative data packet, so as to generate fully formatted created code. For example, the creative delivery subsystem 110 may combine the creative code template 150 with the creative data packet 125 generated by the connection tactics subsystem 105, so as to generate the fully formatted creative code 130. The creative delivery subsystem 110 may accomplish this by performing a series of macro substitutions, including one for the dynamic data packet. The fully formatted creative code 130 may correspond to the fully formatted creative code 500 of FIG. 5.

At block 625, the fully formatted creative code 130 may be communicated to a browser. The browser may then execute the fully formatted creative code 130. In doing so, the browser may execute the applet, which will in turn render the final dynamic advertisement based, at least in part on, the dynamic elements specified within the fully formatted creative code 130.

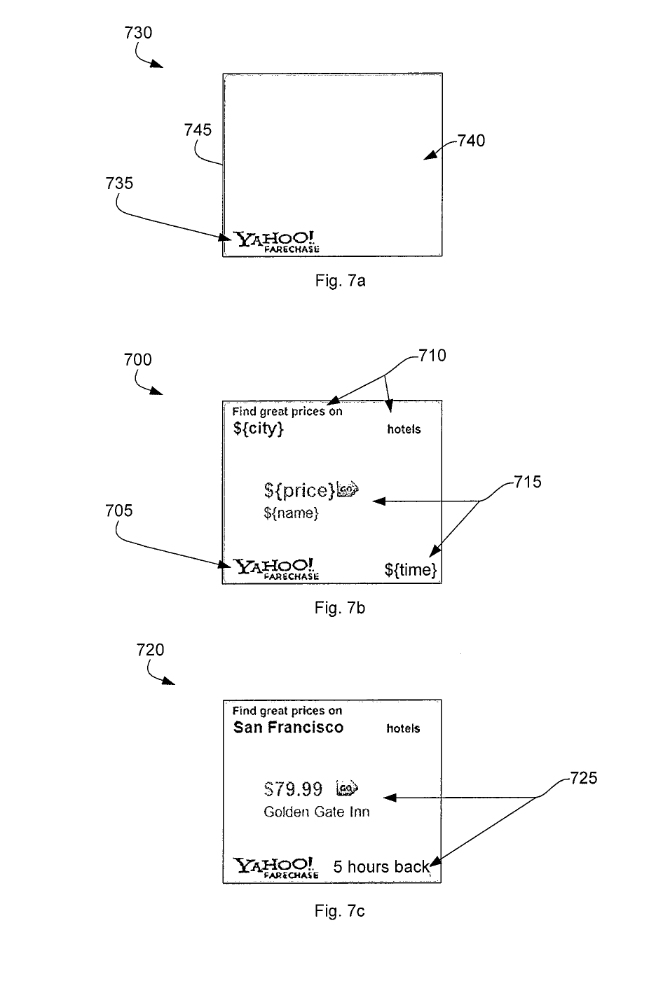

FIG. 7a-FIG. 7c graphically illustrate several stages of the development of a dynamic advertisement. To facilitate the creation of dynamic advertisements, a service provider may provide an application that enables graphically creating the dynamic advertisement. The application may provide a user interface that allows a client to build an entirely custom creative template or may allow the client to build a semi-custom creative template based on a previously generated dynamic advertisement template (DAT). A DAT is essentially browser code that defines a user interface with basic visual and structural elements suitable for display on a web browser.

FIG. 7a is an exemplary DAT 730. The exemplary DAT 730 includes a frame 745, a service provider name 735, and a client creative region 740. In the preferred embodiment, DATs are provided by the service provider and made available to all clients. DATs may also be provided by various third parties. The user interface may allow the client to drag and drop visual components onto the DAT.

FIG. 7b is an exemplary custom user interface 700 based on a DAT. The exemplary user interface 700 includes static elements 710 and dynamic elements 715 that are added by a client. The exemplary user interface 700 also includes information from the DAT, such as the service provider name 705. The static elements 710 correspond to visual aspects of the exemplary user interface that generally remain unchanged from impression to impression, such as the name of the client. Dynamic elements 715 generally include information that may change from impression to impression. When specifying a dynamic element 715, other attributes may be specified, such as the name, type, and default value of the dynamic element 715. Non-visual elements, such as a creative applet and alternate image, may also be specified. After the design is complete, the client may test the exemplary custom user interface 700 by providing test data.

FIG. 7c is an exemplary dynamic advertisement 720 that may be generated by the user interface based on the test data provided. As shown FIG. 7c, the dynamic elements of FIG. 7b are replaced by the data associated with the dynamic elements. Once a satisfactory result is achieved, a creative template associated with the user interface may be stored to the creative database 115.

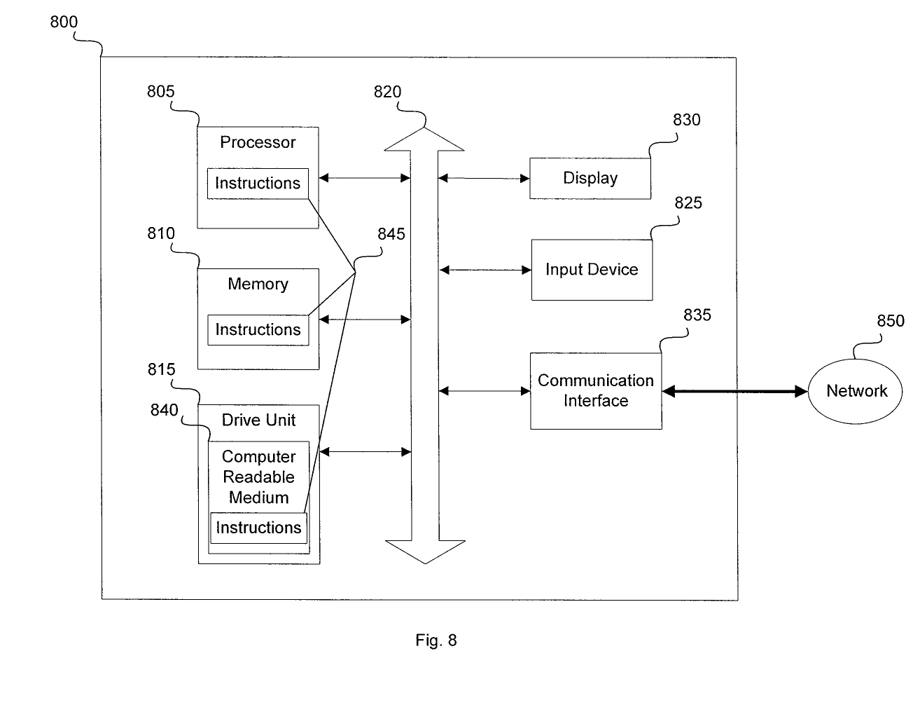

FIG. 8 illustrates a general computer system 800, which may represent the network processor connection tactics subsystem 145, creative delivery subsystem 110, and/or client data server 135 of FIG. 1, or any of the other computing devices referenced herein. The computer system 800 may include a set of instructions 845 that may be executed to cause the computer system 800 to perform any one or more of the methods or computer-based functions disclosed herein. The computer system 800 may operate as a stand-alone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 845 (sequential or otherwise) that specify actions to be taken by that machine. In one embodiment, the computer system 800 may be implemented using electronic devices that provide voice, video or data communication. Further, while a single computer system 800 may be illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 805, such as a central processing unit (CPU), a graphics processing unit (GPU), or both. The processor 805 may be a component in a variety of systems. For example, the processor 805 may be part of a standard personal computer or a workstation. The processor 805 may be one or more general processors, digital signal processors, application specific integrated circuits, field programmable gate arrays, servers, networks, digital circuits, analog circuits, combinations thereof, or other now known or later-developed devices for analyzing and processing data. The processor 805 may implement a software program, such as code generated manually (i.e., programmed).

The computer system 800 may include a memory 810 that can communicate via a bus 820. For example, creative database 115 of FIG. 1 may be stored in the memory. The memory 810 may be a main memory, a static memory, or a dynamic memory. The memory 810 may include, but may not be limited to, computer readable storage media such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one case, the memory 810 may include a cache or random access memory for the processor 805. Alternatively or in addition, the memory 810 may be separate from the processor 805, such as a cache memory of a processor, the system memory, or other memory. The memory 810 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 810 may be operable to store instructions 845 executable by the processor 805. The functions, acts or tasks illustrated in the figures or described herein may be performed by the programmed processor 805 executing the instructions 845 stored in the memory 810. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 800 may further include a display 830, such as a liquid crystal display (LCD), an organic light emitting diode (OLED), a flat panel display, a solid state display, a cathode ray tube (CRT), a projector, a printer or other now known or later-developed display device for outputting determined information. The display 830 may act as an interface for the user to see the functioning of the processor 805, or specifically as an interface with the software stored in the memory 810 or in the drive unit 815.

Additionally, the computer system 800 may include an input device 825 configured to allow a user to interact with any of the components of system 800. The input device 825 may be a number pad, a keyboard, or a cursor control device, such as a mouse, or a joystick, touch screen display, remote control or any other device operative to interact with the system 800.

The computer system 800 may also include a disk or optical drive unit 815. The disk drive unit 815 may include a computer-readable medium 840 in which one or more sets of instructions 845, e.g. software, can be embedded. Further, the instructions 845 may perform one or more of the methods or logic as described herein. The instructions 845 may reside completely, or at least partially, within the memory 810 and/or within the processor 805 during execution by the computer system 800. The memory 810 and the processor 805 also may include computer-readable media as discussed above.

The present disclosure contemplates a computer-readable medium 840 that includes instructions 845 or receives and executes instructions 845 responsive to a propagated signal, so that a device connected to a network 850 may communicate voice, video, audio, images or any other data over the network 850. The instructions 845 may be implemented with hardware, software and/or firmware, or any combination thereof. Further, the instructions 845 may be transmitted or received over the network 850 via a communication interface 835. The communication interface 835 may be a part of the processor 805 or may be a separate component. The communication interface 835 may be created in software or may be a physical connection in hardware. The communication interface 835 may be configured to connect with a network 850, external media, the display 830, or any other components in system 800, or combinations thereof. The connection with the network 850 may be a physical connection, such as a wired Ethernet connection or may be established wirelessly as discussed below. Likewise, the additional connections with other components of the system 800 may be physical connections or may be established wirelessly.

The network 850 may include wired networks, wireless networks, or combinations thereof. The wireless network may be a cellular telephone network, an 802.11, 802.16, 802.20, or WiMax network. Further, the network 850 may be a public network, such as the Internet, a private network, such as an intranet, or combinations thereof, and may utilize a variety of networking protocols now available or later developed including, but not limited to, TCP/IP based networking protocols.

The computer-readable medium 840 may be a single medium, or the computer-readable medium 840 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 840 may include a solid-state memory such as a memory card or other package that houses one or more non-volatile read-only memories. The computer-readable medium 840 also may be a random access memory or other volatile re-writable memory. Additionally, the computer-readable medium 840 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the methods described herein and which, when loaded in a computer system, is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

From the foregoing, it may be seen that the embodiments disclosed herein provide an approach for managing dynamic advertisements. For example, the system enables a client, such as an advertiser, to generate a unique dynamic advertisement or a dynamic advertisement based on a dynamic advertisement template provided by a service provider. The dynamic advertisement includes dynamic elements. Once the dynamic advertisement is complete, a creative template associated with the dynamic advertisement is stored to a database.

When serving the dynamic advertisement, the system selects the appropriate creative template schema, and combines the creative template schema with dynamic data values associated with dynamic elements in the creative template schema, so as to produce a creative data packet. The system then combines the creative data packet with creative code by replacing a well defined place holder in the creative code with the creative data packet, so as to produce fully formatted creative code. The fully formatted creative code is then communicated to a browser.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for generating digital advertisements, the method comprising:
receiving template information that defines dynamic elements of an advertisement;
receiving data associated with the dynamic elements;
generating browser code based on the template information and the data; and
communicating the browser code to a browser.

2. The method according to claim 1, further comprising:
receiving second template information that includes a creative applet reference; and
combining the template information with the browser code.

3. The method according to claim 2, wherein the second template includes a reference to an alternate image that is rendered when an image defined by the creative applet cannot be rendered.

4. The method according to claim 1, wherein the advertisement includes at least one static element defined by a service provider.

5. The method according to claim 1, wherein the advertisement includes at least one static element defined by a client.

6. A method for generating digital advertisements, the method comprising:
communicating a dynamic advertisement template to a client;
receiving static and dynamic element information that defines static and dynamic elements to add to the dynamic advertisement;
generating a creative template that includes the dynamic advertisement template, and static and dynamic element information; and
storing the creative template to a database.

7. The method according to claim 6, further comprising:
receiving dynamic data that corresponds to data associated with the dynamic elements;
generating browser code based on the creative template and the data; and
communicating the browser code to the client.

8. The method according to claim 6, further comprising:
receiving a creative applet reference; and
combining the creative applet reference with the creative template.

9. The method according to claim 8, further comprising:
receiving a reference to an alternate image that is rendered when an image defined by the creative applet cannot be rendered by the creative applet; and
combining the reference to the alternate image, with the creative template.

10. A machine-readable storage medium having stored thereon, a computer program comprising at least one code section for generating digital advertisements, the at least one code section being executable by a machine for causing the machine to perform acts of:
receiving template information that defines dynamic elements of an advertisement;
receiving data associated with the dynamic elements;
generating browser code based on the template information and the data; and
communicating the browser code to a browser.

11. The machine-readable storage according to claim 10, wherein the at least one code section comprises code that enables:
receiving second template information that includes a creative applet reference; and
combining the template information with the browser code.

12. The machine-readable storage according to claim 11, wherein the second template includes a reference to an alternate image that is rendered when an image defined by the creative applet cannot be rendered.

13. The machine-readable storage according to claim 10, wherein the advertisement includes at least one static element defined by a service provider.

14. The machine-readable storage according to claim 10, wherein the advertisement includes at least one static element defined by a client.

15. A machine-readable storage medium having stored thereon, a computer program comprising at least one code section for generating digital advertisements, the at least one code section being executable by a machine for causing the machine to perform acts of:
communicating a dynamic advertisement template to a client;
receiving static and dynamic element information that defines static and dynamic elements to add to the dynamic advertisement;
generating a creative template that includes the dynamic advertisement template, and static and dynamic element information; and
storing the creative template to a database.

16. The machine-readable storage according to claim 15, wherein the at least one code section comprises code that enables:
receiving dynamic data that corresponds to data associated with the dynamic elements;
generating browser code based on the creative template and the data; and
communicating the browser code to the client.

17. The machine-readable storage according to claim 15, wherein the at least one code section comprises code that enables:
receiving a creative applet reference; and
combining the creative applet reference with the creative template.

18. The machine-readable storage according to claim 17, wherein the at least one code section comprises code that enables:
receiving a reference to an alternate image that is rendered when an image defined by the creative applet cannot be rendered by the creative applet; and
combining the reference to the alternate image, with the creative template.

19. A system for generating digital advertisements, the system comprising:
a connection tactics subsystem operable to receive template information that defines dynamic elements of an advertisement, and to receive data associated with the dynamic elements, and to generate browser code based on the template information and the data; and
a creative delivery subsystem operable to communicate the browser code to a browser.

20. The system according to claim 19, wherein the creative delivery subsystem is operable to receive second template information that includes a creative applet reference, and to combine the template information with the browser code.

21. The system according to claim 20, wherein the second template includes a reference to an alternate image that is rendered when an image defined by the creative applet cannot be rendered.

22. A system for generating digital advertisements, the system comprising:
circuitry operable to communicate a dynamic advertisement template to a client, receive static and dynamic element information that defines static and dynamic elements to add to the dynamic advertisement, generate a creative template that includes the dynamic advertisement template, and static and dynamic element information, and store the creative template to a database.

23. The system according to claim 22, wherein the system further comprises:
a connection tactics subsystem operable to receive dynamic data that corresponds to data associated with the dynamic elements, generate browser code based on the creative template and the data; and
a creative delivery subsystem operable to communicate the browser code to the client.

24. The system according to claim 22, wherein the creative delivery subsystem is operable to receive a creative applet reference, and combine the creative applet reference with the creative template.

25. The system according to claim 24, wherein the creative delivery subsystem is operable to receive a reference to an alternate image that is rendered when an image defined by the creative applet cannot be rendered by the creative applet, and combine the reference to the alternate image, with the creative template.
